(19) United States
(12) Patent Application Publication
(10) Pub. No.: US 2007/0202791 A1
(43) Pub. Date: Aug. 30, 2007

(54) Auxiliary exhaust structure and method therfor

(76) Inventors: Shuei-Yuan Lee, Taipei City (TW); Pei-Hsin Pei, Taipei City (TW)

Correspondence Address: RABIN & Berdo, PC, 1101 14TH STREET, NW, SUITE 500, WASHINGTON, DC, 20005, US

(21) Appl. No.: 11/475,159

(22) Filed: Jun. 27, 2006

(30) Foreign Application Priority Data
Feb. 24, 2006 (TW) 095106448

(51) Int. Cl. B08B 15/00

(52) U.S. Cl. 454/49

(57) ABSTRACT

An auxiliary exhaust structure and method therefor are used to exhaust a pollution source of a workstation. The auxiliary exhaust structure includes an exhaust hood and an air feeder. The exhaust hood disposed corresponding to the workstation has a suction port for sucking the pollution source and a deflector extending along the periphery of the suction port for guiding the pollution source. The air feeder generates air flows flowing along the deflector towards the suction port for guiding the pollution source. Therefore, during the exhausting of the pollution source, the gathering effect of the pollution source flowing to the exhaust hood is enhanced and thereby the pollution source is easier to be trapped.

### CROSS-REFERENCE TO RELATED APPLICATIONS

This non-provisional application claims priority under 35 U.S.C. §119(a) on Patent Application No(s). 095106448 filed in Taiwan, R.O.C. on Feb. 24, 2006, the entire contents of which are hereby incorporated by reference.

### BACKGROUND OF THE INVENTION

1. Field of Invention

The present invention relates to an auxiliary exhaust structure and method therefore; more particularly to an auxiliary exhaust structure for exhausting fumes in a workplace, such as a kitchen or a factory, and a method therefor.

2. Related Art

Presently, local exhaust devices are placed around workstations in most workplaces where pollution sources such as fumes, tin solders, organic solvents, lead, dust, or specific chemical substances exist, depending on practical situations, so as to keep personnel safe. Conventional local exhaust devices generally dispose exhaust hoods corresponding to workstations. When a pollution source is sucked by an exhaust hood to flow upwards, in despite of the strong suction of the exhaust hood to exhaust most of the pollution source, the pollution source may diffuse upward and outward due to the suction. In addition, the remaining pollution source may escape everywhere as the pollution source is gathered simultaneously around the inlet.

U.S. Pat. No. 4,788,905 disclosed a fan device disposed correspondingly below the workstation, wherein the fan device generates upward air flows to form upward air curtains around the workstation, so as to prevent the lateral diffusion of the pollution source inside a workstation and reduce environmental side wind.

U.S. Pat. No. 4,902,316 disclosed a fan device to exhaust air to a filter area. As the filter area comprises three filter layers, the fan needs sufficient power to guide the air to pass through the filter area completely.

U.S. Pat. No. 5,042,456 disclosed an air hood ventilation device with side wall and back wall structures. The air hood ventilation device provides upward air curtains between the workstation and the operator and provides perpendicular air flows on the side wall, so as to guide the pollution source to flow to the middle.

U.S. Pat. No. 5,927,268 disclosed an exhaust hood, such that the air is received by the exhaust hood through a plurality of holes, and is then exhausted by a fan device.

Furthermore, in U.S. Pat. No. 6,450,879 and the auxiliary fume exhaust patent proposed by the author of the present invention, i.e., U.S. Pat. No. 6,752,144 both disclosed an exhauster disposed between the workstation and the operator for providing upward air curtains to prevent the pollution source diffusing towards an operator.

However, the prior arts disclosed above fail to entirely take into consideration the upward and outward diffusion of the pollution source when sucked by the exhaust device, the size of the fan device for guiding the pollution source, the interference on the direction of the pollution source flowing towards the exhaust device under the influence of the guiding side wind, and the non-conformity of the exhaust direction of the exhaust device and the flow direction of the pollution source.

### SUMMARY OF THE INVENTION

Accordingly, embodiments of the present invention provide an auxiliary exhaust structure adapted to exhaust fumes in workplaces.

Additional features and advantages of the invention will be set forth in the description which follows, and in part will be apparent to those having ordinary skill in the art upon examination of the following or may be learned from practice of the invention. These and other advantages of the invention will be realized and attained by the structure particularly pointed out in the written description and claims hereof as well as the appended drawings.

To achieve these and other advantages and in accordance with the present invention, as embodied and broadly described herein. The auxiliary exhaust structure comprises an exhaust hood and an air feeder. The exhaust hood disposed corresponding to the workstation has a suction port for sucking a pollution source, and a deflector extending along the periphery of the suction port for guiding the pollution source. The air feeder generates air flows flowing along the deflector towards the suction port. When the pollution source is sucked by the exhaust device to flow from the workstation to the suction port, the air feeder guides the remaining pollution source at the deflector to flow towards the suction port, so as to facilitate the exhausting.

Moreover, to further enhance the effect of the present invention, in the present invention, an exhauster mentioned in the above granted patent proposed by the author of the present invention (U.S. Pat. No. 6,752,144) can be disposed at the outer edge of the workstation. The exhauster can generate air curtains facing the exhaust hood, such that when the pollution source rises from the workstation, it is guided by the air curtains to flow towards the exhaust hood, and the air curtains prevent the pollution source from diffusing outward. Besides, when the pollution source flows to the deflector, the air feeder can guide the pollution source to flow to the suction port. As such, the pollution source can be successfully exhausted.

Furthermore, the present invention also discloses an auxiliary exhaust method. First, an exhaust hood is disposed corresponding to the workstation, and the suction port of the exhaust hood is employed to suck the pollution source. Then, a deflector is disposed, extending along the periphery of the suction port. Moreover, an air feeder is disposed to generate air flows, so as to guide the pollution source to flow from the deflector to the suction port via the air flows, thereby facilitating the exhausting.

According to the auxiliary exhaust structure and the method therefor disclosed by the present invention, the pollution source falls in the surrounding area during the exhaust process instead of diffusing outward. Therefore, the required exhaust effect is ensured and the pollution source is more likely to flow towards the suction port, so the gathering effect is enhanced to make it easier for the exhaust hood to trap the pollution source. Beside, the flow of the pollution source is smoothed, and the direction of the pollution source is not easily interfered by the guiding air flows or environmental side wind. Further, the required guiding air flows can be regulated to meet the auxiliary exhaust effect without taking too much space.

It is to be understood that both the foregoing description and the following detailed description of the present invention are exemplary and explanatory and are intended to provide further explanation of the invention claimed.

### BRIEF DESCRIPTION OF THE DRAWINGS

The present invention will become more fully understood from the detailed description given herein below for illustration only, and which thus is not limitative of the present invention, and wherein:

FIG. 1A is a view of the use state according to the first embodiment of the present invention;

FIG. 1B is a sectional view of FIG. 1A along 1B-1B;

FIG. 2 is a schematic view of the appearance of the air curtain formed according to the second embodiment of the present invention;

FIG. 3 is a bottom view of the air feeder and the suction port according to the present invention;

FIG. 4 is a view of the use state according to the third embodiment of the present invention;

FIG. 5 is a flow chart of the steps of the auxiliary exhaust according to the present invention; and

FIG. 6 is a flow chart of the steps for producing the air curtain according to the present invention.

### DETAILED DESCRIPTION OF THE INVENTION

The auxiliary exhaust structure and method therefor disclosed by the present invention are applied to, but not limited to, an exhaust hood for exhausting fumes. The exhaust interfaces for exhausting fumes in labs, factories, kitchens, and the like having pollution sources can also employ the technology disclosed by the present invention. The exhaust hood is taken as an embodiment of the present invention in the following detailed description.

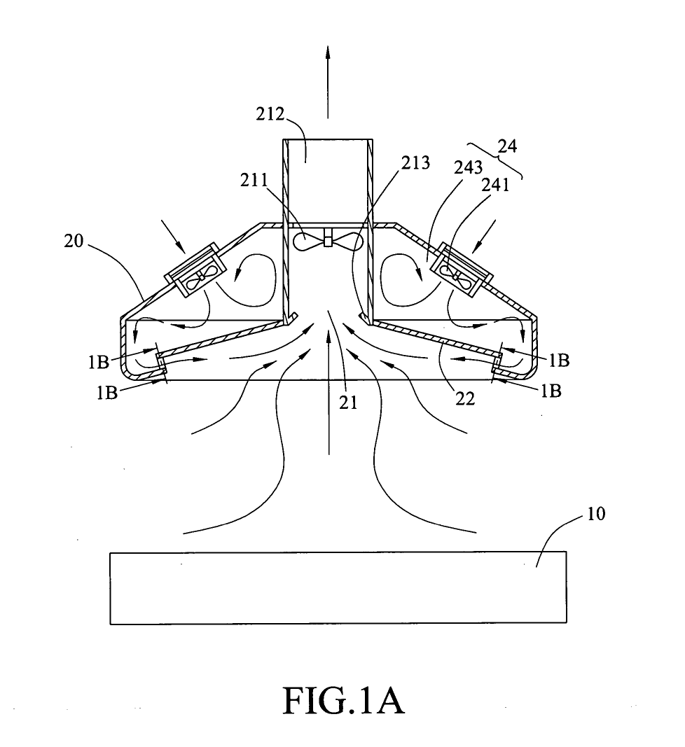

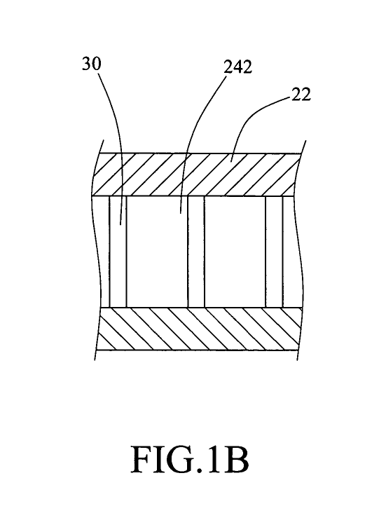

The first embodiment of the auxiliary exhaust structure of the present invention is shown in FIG. 1A, comprising a workstation 10 and an exhaust hood 20 disposed correspondingly.

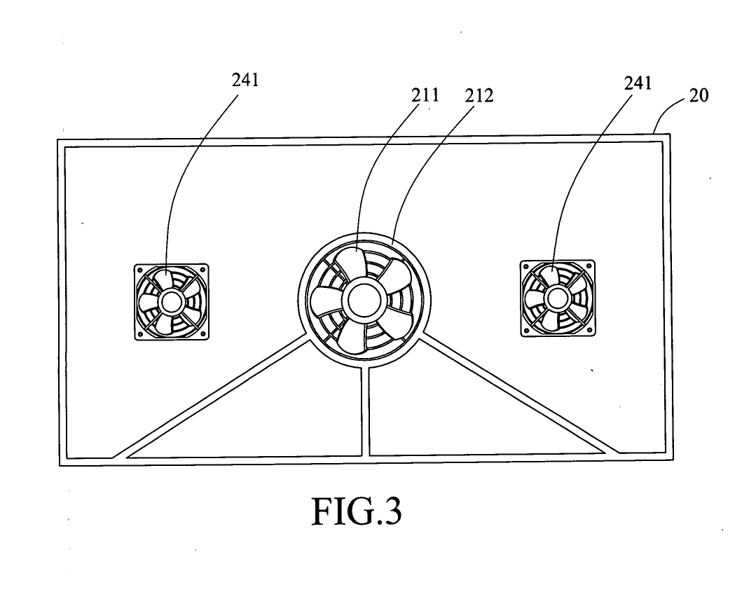

As shown in FIGS. 1A, 1B, and 3, the exhaust hood 20 comprises a suction port 21 and a deflector 22 extending along the periphery of the suction port 21. The deflector 22 forms an angle with the periphery of the suction port 21, such that the deflector 22 is tilted relative to the periphery of the suction port 21. An air feeder 24 disposed at one side of the deflector 22 mainly comprises a fan 241 and an air outlet 242, wherein one end of the air outlet 242 is connected to the fan 241 and the other end of the air outlet 242 is disposed at the edge of the deflector 22. Therefore, the air outlet 242 can receive the air flow generated by the fan 241 and guide the air flow to the deflector 22. In addition, the air outlet 242 is surrounding the edge of the deflector 22 to guide the air flow flowing all over along the deflector 22. The air outlet 242 is provided with ribs 30 to space between the outlet 242 and the deflector 22, and to guide the air flow to the deflector 22.

Continue referring to FIGS. 1A and 1B, the exhaust hood 20 is used to exhaust the pollution source of the workstation 10. The suction port 21 is used to let the pollution source pass. The deflector 22 is used to guide the flow direction of the pollution source. A suction device 211 is disposed at the position of the suction port 21 to suck the pollution source from around the workstation 10. When the pollution source flows near the suction port 21 and the deflector 22 under the suction force, a part of the pollution source directly falling at the suction port 21 is sucked into the suction port 21 and then exhausted via an exhaust channel 212. When the pollution source passes through the exhaust channel 212, the grease and dirt accompanying the pollution source may attach to the exhaust channel 212 and they can be gathered by a grease groove 213 disposed between the suction port 21 and the exhaust channel 212. However, the farther the pollution source is from the suction range of the suction port 21, the less suction force the pollution source will suffer, and thereby the pollution source is not easily exhausted and remains between the workstation 10 and the exhaust hood 20. The pollution source near the deflector 22 is guided to the suction port 21 by the air feeder 24. The air feeder 24 generates air flows by means of the fan 241 and the air flows are sent out from the air outlet 242 with a plurality of ribs 30. The other end of the air outlet 242 is disposed at the edge of the deflector 22, so as to make the air flows flow along the deflector 22 towards the suction port 21. As such, the pollution source guided by the air flows also flows from the periphery of the deflector 22 towards the suction port 21. Then, the pollution source is sucked into the suction port 21 and exhausted through the exhaust channel 212.

Next, the air feeder 24 further comprises an air chamber 243 which is hollow and connected to the fan 241 and the air outlet 242 for receiving the air flow generated by the fan 241, regulating the air pressure of the air flow and then guiding the air flow to the air outlet 242. Besides, the air chamber 243 surrounds the suction port 21. The fan 241 generates air flows to the air chamber 243. When the air flows are gradually accumulated in the air chamber 243 to generate wind pressure, the air flows are forced to flow quickly to the air outlet 242. In addition, as the ribs 30 are disposed at the air outlet 242, the air flows are directional when flowing out of the air outlet 242. Therefore, the air flows can guide the pollution source to flow towards the suction port 21.

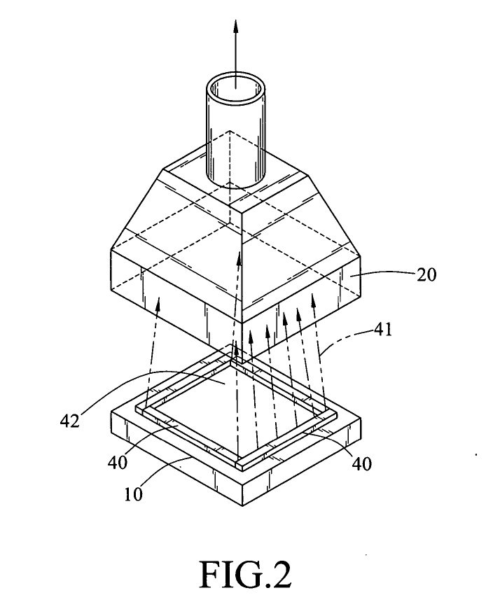

The second embodiment of the auxiliary exhaust structure according to the present invention is shown in FIG. 2, comprising a workstation 10 and an exhaust hood 20 disposed correspondingly. To further enhance the effect of the invention, the workstation 10 further comprises an exhauster 40 disposed at the outer edge of the workstation 10 and generating air curtains 41 facing the exhaust hood 20. The air curtains 41 facing the suction port 21 of the exhaust hood 20 can form air walls (only one air wall formed by the air curtains 41 of the exhauster 40 is shown as a representative). The air walls are used to make the air curtains 41 generated by the exhauster 40, the workstation 10, and the exhaust hood 20 together constitute a surrounding space 42 for preventing the pollution source diffusing outward

Afterward, as shown in FIGS. 1A and 2, the exhaust hood 20 is used to exhaust the pollution source of the workstation 10. The suction port 21 is used to suck the pollution source, while the deflector 22 is used to guide the pollution source. The suction device 211 is disposed at the position of the suction port 21 for sucking the pollution source from around the workstation 10. Meanwhile, the air curtains 41 generated by the exhauster 40 and facing the suction port 21 can blow the pollution source to flow towards the suction port 21. When the pollution source flows near the suction port 21 and the deflector 22 under the influence of the suction and blowing forces, a part of the pollution source directly falling at the suction port 21 is sucked into the suction port 21, and is then exhausted through the exhaust channel 212. When the pollution source passes through the exhaust channel 212, the grease and dirt accompanying the pollution source may attach to the exhaust channel 212 and can be gathered via the grease groove 213 disposed between the suction port 21 and the exhaust channel 212. However, the farther the pollution source is away from the suction range of the suction port 21, the less suction force the pollution source will suffer, and thereby the pollution source is not easily exhausted and remains between the workstation 10 and the exhaust hood 20. The pollution source near the deflector 22 is guided to the suction port 21 by the air feeder 24. The air feeder 24 generates air flows by means of the fan 241 and the air flows are sent out from the air outlet 242 with a plurality of ribs. The other end of the air outlet 242 is disposed at the edge of the deflector 22, so as to make the air flows flow along the deflector 22 towards the suction port 21. As such, the pollution source guided by the air flows also flows from the periphery of the deflector 22 towards the suction port 21. Then, the pollution source is sucked into the suction port 21 and exhausted through the exhaust channel 212.

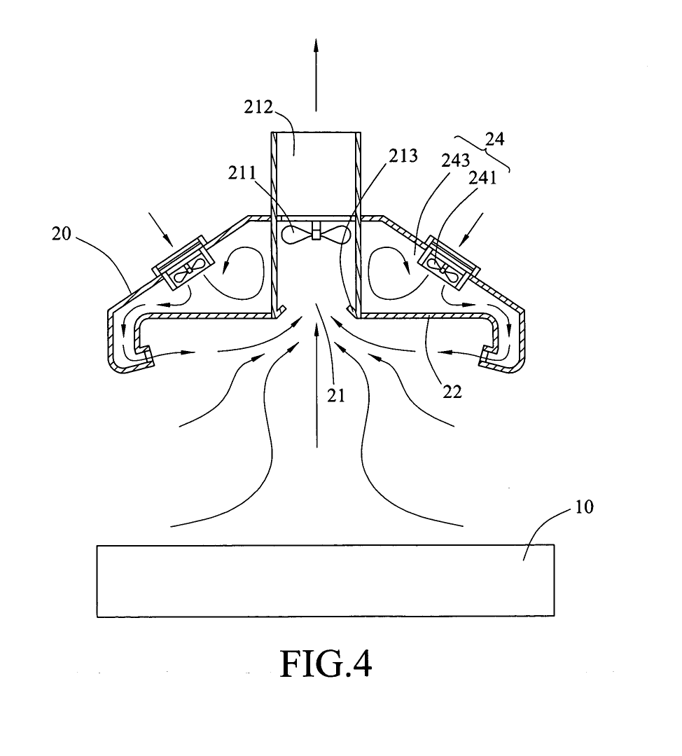

As shown in FIG. 4, it is the third embodiment of the auxiliary exhaust structure according to the present invention, wherein the deflector 22 is parallel to the periphery of the suction port 21. The pollution source near the deflector 22 is guided to the suction port 21 by the air feeder 24. The air feeder 24 generates air flows by means of the fan 241 and the air flows are sent out from the air outlet 242 with a plurality of ribs. The other end of the air outlet 242 is disposed at the edge of the deflector 22 so as to make the air flows flow along the deflector 22 towards the suction port 21. As such, the pollution source guided by the air flows also flows from the periphery of the deflector 22 towards the suction port 21. Then, the pollution source is sucked into the suction port 21 and exhausted through the exhaust channel 212.

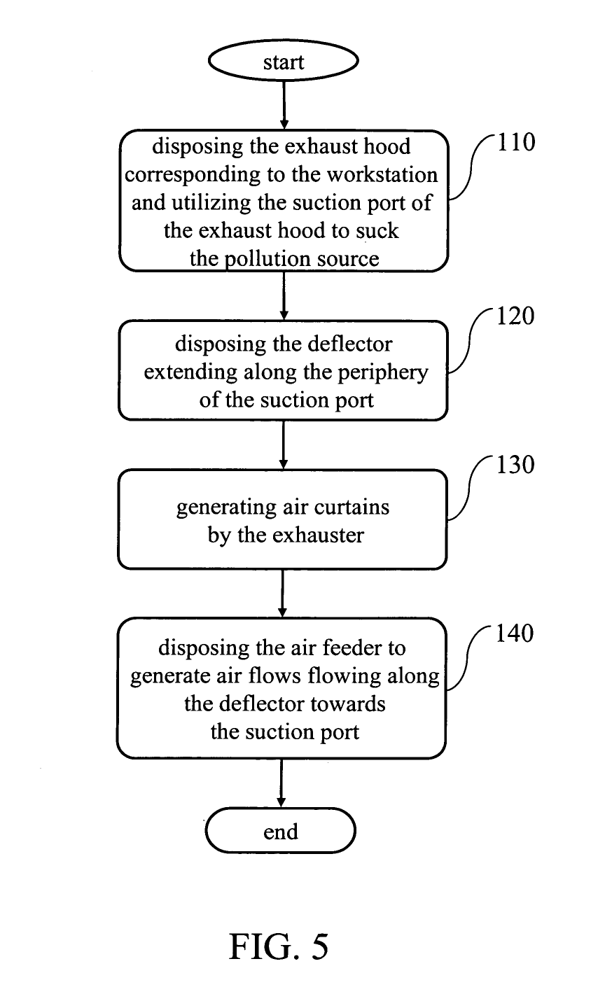

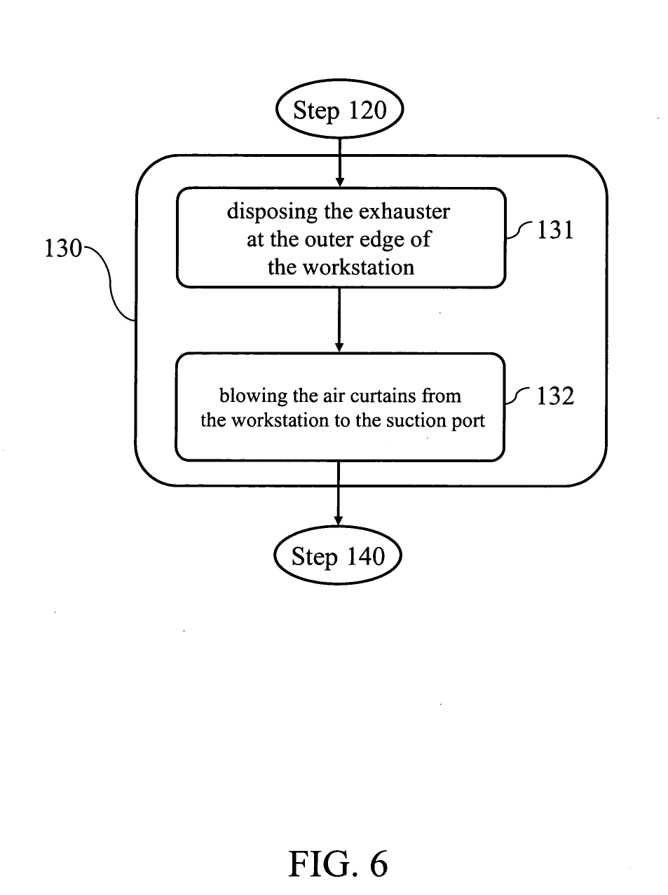

As shown in FIGS. 5 and 6, the exhaust hood 20 corresponding to the workstation 10 is disposed and the suction port 21 of the exhaust hood 20 is employed to suck the pollution source (Step 110). The suction device 211 is disposed at the position of the suction port 21 for sucking the pollution source from around the workstation 10. Then, the deflector 22 is disposed extending along the periphery of the suction port 21 (Step 120). The deflector 22 faces and forms an angle with the periphery of the suction port 21 or is parallel thereto. The exhauster 40 is disposed at the outer edge of the workstation to generate the air curtains 41 (Step 130), i.e., the exhauster 40 is disposed at the outer edge of the workstation 10 (Step 131) to generate the air curtains 41 from the workstation 10 to the suction port 21 (Step 132). As the air curtains 41 face the suction port 21, a blowing force is provided to achieve a smooth flow of the pollution source. Then, the air feeder 24 is disposed to generate air flows by means of the fan 241 and the air flows flow along the deflector 22 to the suction port 21 (Step 140). As one end of the air outlet 242 of the air feeder 24 is disposed along the edge of the deflector 22, the air flows generated by the air feeder 24 can also be exhausted along the edge of the deflector 22, so as to guide the pollution source to flow from the deflector 22 towards the suction port 21.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An auxiliary exhaust structure, for exhausting a pollution source in a workstation, comprising:
an exhaust hood, disposed corresponding to the workstation, having a suction port for sucking the pollution source and a deflector extending along the periphery of the suction port for guiding the pollution source; and
an air feeder, for generating an air flow flowing along the deflector towards the suction port.

2. The auxiliary exhaust structure as claimed in claim 1, wherein the air feeder comprises:
a fan, for generating an air flow; and
an air outlet, disposed at the edge of the deflector to receive and guide the air flow to the deflector.

3. The auxiliary exhaust structure as claimed in claim 2, wherein the air feeder further comprises an air chamber to receive the air flow generated by the fan, regulate the air pressure of the air flow and guide the regulated air flow to the air outlet.

4. The auxiliary exhaust structure as claimed in claim 3, wherein the air chamber is hollow.

5. The auxiliary exhaust structure as claimed in claim 2, wherein the air outlet is provided with a plurality of ribs.

6. The auxiliary exhaust structure as claimed in claim 3, wherein the air chamber surrounds the suction port.

7. The auxiliary exhaust structure as claimed in claim 2, wherein the air outlet is surrounding the edge of the deflector.

8. The auxiliary exhaust structure as claimed in claim 1, wherein the deflector forms an angle with the periphery of the suction port.

9. An auxiliary exhaust structure, for exhausting a pollution source of a workstation, comprising:
an exhaust hood, disposed corresponding to the workstation, having a suction port for sucking the pollution source and a deflector extending along the periphery of the suction port for guiding the pollution source;
an air feeder, for generating an air flow flowing along the deflector towards the suction port; and
an exhauster, disposed at the outer edge of the workstation, for generating an air curtain facing the exhaust hood.

10. The auxiliary exhaust structure as claimed in claim 9, wherein the air feeder comprises:
a fan, for generating the air flow; and
an air outlet, disposed at the edge of the deflector to receive and guide the air flow to the deflector.

11. The auxiliary exhaust structure as claimed in claim 10, wherein the air feeder further comprises an air chamber to receive the air flow generated by the fan, regulate the air pressure of the air flow and guide the regulated air flow to the air outlet.

12. The auxiliary exhaust structure as claimed in claim 11, wherein the air chamber is hollow.

13. The auxiliary exhaust structure as claimed in claim 10, wherein the air outlet is provided with a plurality of ribs.

14. The auxiliary exhaust structure as claimed in claim 11, wherein the air chamber surrounds the suction port.

15. The auxiliary exhaust structure as claimed in claim 10, wherein the air outlet is surrounding the edge of the deflector.

16. The auxiliary exhaust structure as claimed in claim 9, wherein the deflector forms an angles with the periphery of the suction port.

17. The auxiliary exhaust structure as claimed in claim 9, wherein the air curtain faces the suction port.

18. The auxiliary exhaust structure as claimed in claim 9, wherein the air curtain, the workstation, and the exhaust hood together form a surrounding space to surround the pollution source.

19. An auxiliary exhaust method, for exhausting a pollution source of a workstation, comprising:
disposing an exhaust hood corresponding to the workstation, and utilizing a suction port of the exhaust hood to suck the pollution source;
disposing a deflector along the periphery of the suction port; and
disposing an air feeder to generate an air flow flowing along the deflector towards the suction port.

20. The auxiliary exhaust method as claimed in claim 19, wherein before the step of disposing an air feeder to generate an air flow, further comprises a step of disposing an exhauster at the outer edge of the workstation and generating an air curtain from the workstation towards the suction port.
